(19) United States
(12) Patent Application Publication
(10) Pub. No.: US 2023/0354268 A1
(43) Pub. Date: Nov. 2, 2023

(54) METHOD AND APPARATUS FOR RESOURCE ALLOCATION FOR SIDELINK POSITIONING IN A WIRELESS COMMUNICATION SYSTEM

(71) Applicant: Samsung Electronics Co., Ltd., Gyeonggi-do (KR)

(72) Inventors: Miao ZHOU, Beijing (CN); Qi XIONG, Beijing (CN); Feifei SUN, Beijing (CN)

(21) Appl. No.: 18/138,881

(22) Filed: Apr. 25, 2023

(30) Foreign Application Priority Data
Apr. 27, 2022 (CN) 202210458454.8

(51) Int. Cl. H04W 72/02; H04W 64/00; H04W 72/25

(52) U.S. Cl. CPC H04W 72/02; H04W 64/00; H04W 72/25

(57) ABSTRACT

The disclosure relates to methods and apparatuses in a 5G or 6G communication system. Resources are determined for transmitting a sidelink positioning signal. The sidelink positioning signal is transmitted on the determined resources. Determining the resources for transmitting the sidelink positioning signal includes at least one of: determining the resources for transmitting the sidelink positioning signal based on at least one of a mapping rule and specific parameters; determining the resources for transmitting the sidelink positioning signal based on information indicated by received first sidelink control information sidelink control information (SCI); determining the resources for transmitting the sidelink positioning signal based on received inter-node coordination information; determining the resources for transmitting the sidelink positioning signal based on information indicated in request signaling if triggered by the request signaling to transmit the sidelink positioning signal; and determining the resources for transmitting the sidelink positioning signal based on channel sensing.

### PRIORITY

This application claims priority under 35 U.S.C. 119(a) to Chinese Application No. 202210458454.8, filed in the China National Intellectual Property Administration on Apr. 27, 2022, the contents of which are incorporated herein by reference.

### BACKGROUND

### 1. Field

The present disclosure relates generally to wireless communication, and more particularly, to a method for sidelink communication based positioning, and a device thereof, in a fifth generation (5G) new radio (NR) access technology system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure relates to wireless communication systems and, more specifically, the present disclosure relates to a method and an apparatus for resource allocation for sidelink positioning in a wireless communication system.

In the wireless communication system, the positioning technology is implemented based on a UE receiving/transmitting the signal/channel for positioning from/to the base station. Therefore, the positioning function of UE depends on the distribution of base stations and network coverage, which requires a high cost of network layout. For example, the positioning accuracy of UE is poor when the network layout is sparse, and it is difficult to implement the positioning function when the UE is outside the cell coverage. Therefore, the introduction of a sidelink communication-based positioning technology may improve the applicable scenarios of positioning technology and positioning accuracy in most scenarios effectively.

The sidelink communication based positioning technology may be implemented based the UE receiving/transmitting the signal/channel for positioning from/to other UEs, and the reception/transmission mainly occurs on the sidelink channel instead of the uplink/downlink channel in the traditional positioning technology. Therefore, a method is introduced that enables the UE to determine whether to perform, and which resources to use to perform, reception and transmission of sidelink signal/channel for positioning.

According to an embodiment, a method performed by a node device in a communication system is provided. Resources are determined for transmitting a sidelink positioning signal. The sidelink positioning signal is transmitted on the determined resources. Determining the resources for transmitting the sidelink positioning signal includes at least one of: determining the resources for transmitting the sidelink positioning signal based on at least one of a mapping rule and specific parameters; determining the resources for transmitting the sidelink positioning signal based on information indicated by received first sidelink control information SCI; determining the resources for transmitting the sidelink positioning signal based on received inter-node coordination information; determining the resources for transmitting the sidelink positioning signal based on information indicated in request signaling if triggered by the request signaling to transmit the sidelink positioning signal; or determining the resources for transmitting the sidelink positioning signal based on channel sensing. In an embodiment, in some implementations, the sidelink positioning signal includes at least one of a positioning reference signal (PRS), a sounding reference signal (SRS), a positioning reference signal for sidelink, and configuration signaling related to positioning.

In an embodiment, in some implementations, the method further includes obtaining, from a higher layer or other nodes, at least one of the following: information of a resource pool for transmitting the sidelink positioning signal; information of a resource set for transmitting the sidelink positioning signal; and information of resources for transmitting the sidelink positioning signal.

In an embodiment, in some implementations, determining the sidelink positioning signal is multiplexed on the physical sidelink shared channel (PSSCH) based on the information indicated by at least one of the received first SCI, the inter-node coordination information, and the request signaling, and/or based on the configuration of the higher layer or the base station, and/or based on predefined rule.

In an embodiment, in some implementations, determining the resources for transmitting the sidelink positioning signal based on the mapping rule and/or the specific parameters includes at least one of the following: obtaining a plurality of resource sets, and determining at least one resource set among the plurality of resource sets for transmitting the sidelink positioning signal based on the mapping rule and/or specific parameters; and obtaining a plurality of resources in one or more resource sets, and determining at least one resource among the plurality of resources for transmitting the sidelink positioning signal based on the mapping rule.

In an embodiment, in some implementations, after determining that at least one resource set is used for transmitting the sidelink positioning signal, determine the resources for transmitting the sidelink positioning signal in the at least one resource set, or determine that the at least one resource set is used for transmitting the sidelink positioning signal.

In an embodiment, in some implementations, after determining that at least one resource is used for transmitting the sidelink positioning signal, determine the resource used for transmitting the sidelink positioning signal in the at least one resource, or determine that the at least one resource is used for transmitting the sidelink positioning signal.

In an embodiment, in some implementations, obtaining the information of at least one resource set and/or at least one resource includes at least one of the following: obtaining from the information of the resource pool for transmitting the sidelink positioning signal; obtaining from the configuration signaling dedicated to the node device; and obtaining from signaling indicated by other node devices.

In an embodiment, in some implementations, determining the resources for transmitting the sidelink positioning signal based on the information indicated by the received first SCI includes at least one of the following: if the first SCI indicates the resources for the sidelink positioning signal, determining that the resources indicated by the first SCI are used for transmitting the sidelink positioning signal, or determining that other resources except the resources indicated by the first SCI are used for transmitting the sidelink positioning signal; if the sidelink positioning signal is multiplexed on the PSSCH and the first SCI indicates PSSCH resources, determining that the PSSCH resources indicated by the first SCI are used for transmitting the sidelink positioning signal, or determining that other resources except the PSSCH resources indicated by the first SCI are used for transmitting the sidelink positioning signal; and if the sidelink positioning signal is multiplexed on the PSSCH and the first SCI indicates resources for the sidelink positioning signal and PSSCH resources, determining that the resources indicated by the first SCI are used for transmitting the sidelink positioning signal, or other resources except the resources indicated by the first SCI are used for transmitting the sidelink positioning signal.

In an embodiment, in some implementations, determining the resources for transmitting the sidelink positioning signal based on the received inter-node coordination information includes at least one of the following: if the inter-node coordination information indicates the resources for the sidelink positioning signal, determining that the resources indicated by the inter-node coordination information are used for transmitting the sidelink positioning signal; if the sidelink positioning signal is multiplexed on the PSSCH and the inter-node coordination information indicates the PSSCH resources, determining that the PSSCH resources indicated by the inter-node coordination information are used for transmitting the sidelink positioning signal; and if the sidelink positioning signal is multiplexed on the PSSCH and the inter-node coordination information indicates the resources for the sidelink positioning signal and PSSCH resources, determining that the resources indicated by the inter-node coordination information are used for transmitting the sidelink positioning signal.

In an embodiment, in some implementations, determining the resources for transmitting the sidelink positioning signal based on the information indicated in the request signaling includes at least one of the following: if the request signaling indicates the resources for the sidelink positioning signal, determining that the resources indicated by the request signaling are used for transmitting the sidelink positioning signal; if the sidelink positioning signal is multiplexed on the PSSCH and the request signaling indicates the PSSCH resources, determining that the PSSCH resources indicated by the request signaling are used for transmitting the sidelink positioning signal; and if the sidelink positioning signal is multiplexed on the PSSCH and the request signaling indicates the resources for the sidelink positioning signal and PSSCH resources, determining that the resources indicated by the request signaling are used for transmitting the sidelink positioning signal.

In an embodiment, in some implementations, determining the resources for transmitting the sidelink positioning signal based on channel sensing includes: determining a candidate resource set; obtaining a monitoring result of a channel within a resource sensing window; excluding candidate resources satisfying specific conditions from the candidate resource set based on the monitoring result; and determining the resources for transmitting the sidelink positioning signal from the remaining candidate resources.

In an embodiment, in some implementations, the specific conditions include at least one of: lacking corresponding monitoring results, conflicting with reserved data resources, and conflicting with reserved sidelink positioning signal resources.

In an embodiment, in some implementations, the method further includes at least one of the: determining the resources used by a second SCI associated with the sidelink positioning signal, and transmitting the second SCI on the resources used by the second SCI; and transmitting the sidelink positioning signal and the second SCI associated with the sidelink positioning signal on the determined resources for transmitting the sidelink positioning signal.

In an embodiment, in some implementations, the second SCI associated with the sidelink positioning signal includes information indicating resources for the sidelink positioning signal and/or PSSCH resources, wherein: the second SCI indicates the resource location used by the associated sidelink positioning signal; and/or the second SCI indicates the subsequent other resource locations to be used by the sidelink positioning signal; and/or the second SCI indicates the information of the resource set used by the associated sidelink positioning signal; and/or the second SCI indicates the information of the subsequent other resource sets to be used by the sidelink positioning signal; and/or the second SCI indicates the information of resources used by the associated sidelink positioning signal; and/or the second SCI indicates information of the subsequent other resources to be used by the sidelink positioning signal; and/or the second SCI indicates the resource location of the sidelink positioning signal in the same resource pool as the second SCI; and/or the second SCI indicates the resource location of PSSCH in the same resource pool as the second SCI; and/or the second SCI indicates the resource location of the sidelink positioning signal in different resource pool from the second SCI; and/or the second SCI indicates the physical quantity based parameters of the sidelink positioning signal.

According to an embodiment, a method performed by a node device in a communication system is provided. Resources are determined for receiving a sidelink positioning signal. The sidelink positioning signal is received on the determined resource, and the sidelink positioning signal is measured. Determining the resources for receiving the sidelink positioning signal includes at least one of: determining the resources for receiving the sidelink positioning signals based on at least one of a mapping rule and specific parameters; determining the resources for receiving the sidelink positioning signal based on information indicated by received first sidelink control information SCI; determining the resources for receiving the sidelink positioning signal based on received inter-node coordination information; determining the resources for receiving the sidelink positioning signal based on information indicated in request signaling if triggered by the request signaling to receive the sidelink positioning signal; and determining the resources for receiving the sidelink positioning signal based on channel sensing. In an embodiment, in some implementations, the sidelink positioning signal includes at least one of a positioning reference signal (PRS), a sounding reference signal (SRS), a positioning reference signal for sidelink, and configuration signaling related to positioning.

In an embodiment, in some implementations, the method further includes obtaining, from a higher layer or other nodes, at least one of the following: information of a resource pool for receiving the sidelink positioning signal; information of a resource set for receiving the sidelink positioning signal; and information of resources for receiving the sidelink positioning signal.

In an embodiment, in some implementations, determining the sidelink positioning signal is multiplexed on the physical sidelink shared channel (PSSCH) based on the information indicated by at least one of the received first SCI, the inter-node coordination information, and the request signaling, and/or based on the configuration of the higher layer or the base station, and/or based on predefined rule.

In an embodiment, in some implementations, determining the resources for receiving the sidelink positioning signal based on the mapping rule and/or the specific parameters includes at least one of the following: obtaining a plurality of resource sets, and determining at least one resource set among the plurality of resource sets for receiving the sidelink positioning signal based on the mapping rule and/or specific parameters; obtaining a plurality of resources in one or more resource sets, and determining at least one resource among the plurality of resources for receiving the sidelink positioning signal based on the mapping rule.

In an embodiment, in some implementations, after determining that at least one resource set is used for receiving the sidelink positioning signal, determine the resources used for receiving the sidelink positioning signal in the at least one resource set, or determine that the at least one resource set is used for receiving the sidelink positioning signal.

In an embodiment, in some implementations, after determining that at least one resource is used for receiving the sidelink positioning signal, determine the resources used for receiving the sidelink positioning signal in the at least one resource, or determine that the at least one resource is used for receiving the sidelink positioning signal.

In an embodiment, in some implementations, obtaining the information of at least one resource set and/or at least one resource includes at least one of the following: obtaining from the information of the resource pool for transmitting the sidelink positioning signal; obtaining from the configuration signaling dedicated to the node device; and obtaining from signaling indicated by other node devices.

In an embodiment, in some implementations, determining the resources for receiving the sidelink positioning signal based on the information indicated by the received first SCI includes at least one of the following: if the first SCI indicates the resources for the sidelink positioning signal, determining that the resources indicated by the first SCI are used for receiving the sidelink positioning signal, or determining that other resources except the resources indicated by the first SCI are used for receiving the sidelink positioning signal; if the sidelink positioning signal is multiplexed on the PSSCH and the first SCI indicates PSSCH resources, determining that the PSSCH resources indicated by the first SCI are used for receiving the sidelink positioning signal, or determining that other resources except the PSSCH resources indicated by the first SCI are used for receiving the sidelink positioning signal; and if the sidelink positioning signal is multiplexed on the PSSCH and the first SCI indicates resources for the sidelink positioning signal and the PSSCH, determining that the resources indicated by the first SCI are used for receiving the sidelink positioning signal, or determining that other resources except the resources indicated by the first SCI are used for receiving the sidelink positioning signal.

In an embodiment, in some implementations, determining the resources for receiving the sidelink positioning signal based on the received inter-node coordination information further includes at least one of the following: if the inter-node coordination information indicates the resources for the sidelink positioning signal, determining that the resources indicated by the inter-node coordination information are used for receiving the sidelink positioning signal; if the sidelink positioning signal is multiplexed on the PSSCH and the inter-node coordination information indicates the PSSCH resources, determining that the PSSCH resources indicated by the inter-node coordination information are used for receiving the sidelink positioning signal; if the sidelink positioning signal is multiplexed on the PSSCH and the inter-node coordination information indicates the resources for the sidelink positioning signal and PSSCH resources, determining that the resources indicated by the inter-node coordination information are used for receiving the sidelink positioning signal.

In an embodiment, in some implementations, determining the resources for receiving the sidelink positioning signal based on the information indicated in the request signaling includes at least one of the following: if the request signaling indicates the resources for the sidelink positioning signal, determining that the resources indicated by the request signaling are used for receiving the sidelink positioning signal; if the sidelink positioning signal is multiplexed on the PSSCH and the request signaling indicates the PSSCH resources, determining that the PSSCH resources indicated by the request signaling are used for receiving the sidelink positioning signal; and if the sidelink positioning signal is multiplexed on the PSSCH and the request signaling indicates the resources for the sidelink positioning signal and PSSCH resources, determining that the resources indicated by the request signaling are used for receiving the sidelink positioning signal.

In an embodiment, in some implementations, the method further includes at least one of the following: determining the resources used by the first SCI associated with the sidelink positioning signal, and receiving the first SCI on the resources used by the first SCI; receiving the sidelink positioning signal and a third SCI associated with the sidelink positioning signal on the determined resources for receiving the sidelink positioning signal.

According to an embodiment, a node device is also provided. The node device includes a transceiver and a processor coupled to the transceiver. The processor is configured to determine resources for transmitting a sidelink positioning signal, and transmit the sidelink positioning signal on the determined resources. Determining the resources for transmitting the sidelink positioning signal includes at least one of: determining the resources for transmitting the sidelink positioning signal based on at least one of a mapping rule and specific parameters; determining the resources for transmitting the sidelink positioning signal based on information indicated by received first sidelink control information SCI; determining the resources for transmitting the sidelink positioning signal based on received inter-node coordination information; determining the resources for transmitting the sidelink positioning signal based on information indicated in request signaling if triggered by the request signaling to transmit the sidelink positioning signal; and determining the resources for transmitting the sidelink positioning signal based on channel sensing. Aspects of the present disclosure provide efficient communication methods in a wireless communication system.

### BRIEF DESCRIPTION OF THE DRAWINGS

The above and other aspects, features, and advantages of the disclosure will be more apparent from the following detailed description when taken in conjunction with the accompanying drawings, in which:

FIG. 1 is a diagram illustrating a wireless network, according to an embodiment;

FIG. 2A is a diagram illustrating a wireless transmission and reception path, according to an embodiment;

FIG. 2B is a diagram illustrating a wireless transmission and reception path, according to an embodiment;

FIG. 3A is a diagram illustrating a UE, according to an embodiment;

FIG. 3B is a diagram illustrating a gNB, according to an embodiment;

FIG. 4A is a flowchart illustrating a method, according to an embodiment;

FIG. 4B is a flowchart illustrating a method, according to another embodiment;

FIG. 5 is a flowchart illustrating a method of determining resources for transmitting sidelink positioning signals based on channel sensing, according to an embodiment;

FIG. 6 is a block diagram illustrating a UE, according to an embodiment; and

FIG. 7 is a block diagram illustrating a base station, according to an embodiment.

### DETAILED DESCRIPTION

Embodiments of the disclosure are described in detail with reference to the accompanying drawings. It should be noted that similar components are designated by similar reference numerals although they are illustrated indifferent drawings. Detailed descriptions of constructions or processes known in the art may be omitted to avoid obscuring the subject matter of the disclosure.

The 5G NR system includes the evolution of sidelink communication. As an evolved version of LTE V2X technology, NR V2X technology is formulated in version 16, and its performance in all aspects is superior. In 3GPP Release 17, the 5G NR system may further extend NR V2X to other disclosure scenarios, such as commercial sidelink communication and public safety (PS) scenarios. In 3GPP Release 18, 5G NR sidelink will further introduce the evolution corresponding to other scenarios and disclosures, such as sidelink technology in high frequency (e.g., FR2), unlicensed frequency band, and sidelink technology corresponding to specific disclosures such as positioning.

The following description includes various specific details to facilitate understanding but should only be considered as exemplary. Therefore, those skilled in the art will recognize that various changes and modifications can be made to the various embodiments described herein without departing from the scope and spirit of the disclosure.

Terms and expressions used in the following specification and claims are not limited to their dictionary meanings, but are only used by the inventors to enable a clear and consistent understanding of the present disclosure. Therefore, it should be obvious to those skilled in the art that the following descriptions of various embodiments of the present disclosure are provided only for the purpose of illustration and not for the purpose of limiting the present disclosure as defined by the appended claims and their equivalents.

It should be understood that singular forms of “a”, “an” and “the” include plural referents, unless the context clearly indicates otherwise. Thus, for example, references to “component surfaces” include references to one or more such surfaces.

The term “including” or “may include” refers to the existence of the corresponding disclosed functions, operations or components that can be used in various embodiments of the present disclosure, rather than limiting the existence of one or more additional functions, operations or features. In addition, the term “including” or “having” can be interpreted to indicate certain features, numbers, steps, operations, constituent elements, components or combinations thereof, but should not be interpreted to exclude the possibility of the existence of one or more other features, numbers, steps, operations, constituent elements, components or combinations thereof

The term “or” used in various embodiments of the present disclosure includes any listed terms and all combinations thereof. For example, “A or B” may include A, B, or both A and B.

Unless otherwise defined, all terms (including technical terms or scientific terms) used in this disclosure have the same meanings as understood by those skilled in the art as described in this disclosure. Common terms as defined in dictionaries are interpreted to have meanings consistent with the context in relevant technical fields, and they should not be interpreted as idealized or excessively formally, unless explicitly defined as such in this disclosure.

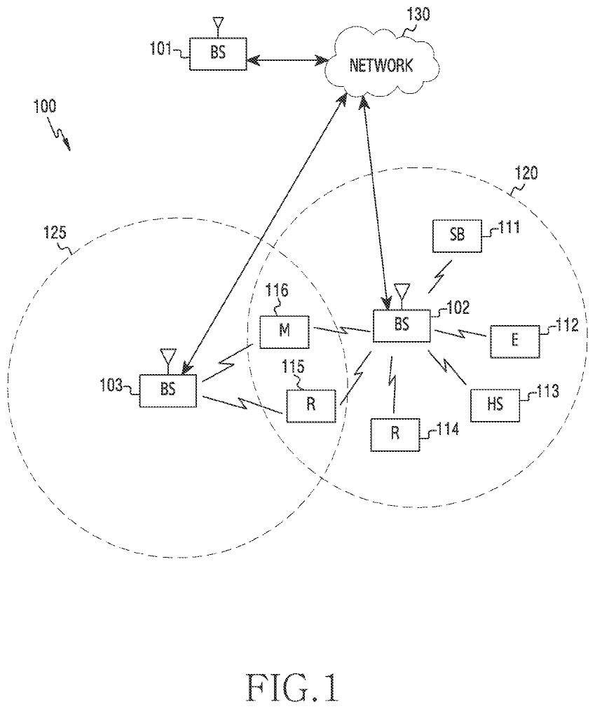

FIG. 1 through FIG. 7, discussed below, and the various embodiments used to describe the principles of the disclosure are by way of illustration only and should not be construed in any way to limit the scope of the disclosure. Those skilled in the art will understand that the principles of the disclosure may be implemented in any suitably arranged system or device.

FIG. 1 is a diagram illustrating a wireless network, according to an embodiment. The embodiment of a wireless network 100 shown in FIG. 1 area for illustration only. Other embodiments of the wireless network 100 can be used without departing from the scope of the present disclosure.

The wireless network 100 includes a first gNodeB (gNB) 101, a second gNB 102, and a third gNB 103. The first gNB 101 communicates with the second gNB 102 and the third gNB 103. The first gNB 101 also communicates with at least one Internet protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms, such as “mobile station”, “user station”, “remote terminal”, “wireless terminal” or “user apparatus” can be used instead of “user equipment” or “UE”. For convenience, the terms “user equipment” and “UE” are used herein to refer to remote wireless devices that wirelessly access the gNB, no matter whether the UE is a mobile device (e.g., a mobile phone or a smart phone) or a fixed device (e.g., a desktop computer or a vending machine).

The second gNB 102 provides wireless broadband access to the network 130 for a first plurality of UEs within a coverage area 120 of the second gNB 102. The first plurality of UEs include a first UE 111, which may be located in a small business (SB); a second UE 112, which may be located in an enterprise (E); a third UE 113, which may be located in a WiFi hotspot (HS); a fourth UE 114, which may be located in a first residence (R); a fifth UE 115, which may be located in a second residence (R); a sixth UE 116, which may be a mobile device (M), such as a cellular phone, a wireless laptop computer, a wireless PDA, etc. The third gNB 103 provides wireless broadband access to network 130 for a second plurality of UEs within a coverage area 125 of gNB 103. The second plurality of UEs include the fifth UE 115 and the sixth UE 116. In some embodiments, one or more of the first through third gNBs 101-103 can communicate with each other and with the first through sixth UEs 111-116 using 5G, LTE, LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As described in greater detail below, one or more of the first gNB 101, the second gNB 102, and the third gNB 103 includes a 2D antenna array as described in embodiments of the disclosure. One or more of the first gNB 101, the second gNB 102, and the third gNB 103 support codebook designs and structures for systems with 2D antenna arrays.

Although FIG. 1 illustrates an example of the wireless network 100, various changes can be made to FIG. 1. The wireless network 100 may include any number of gNBs and any number of UEs in any suitable arrangement, for example. Furthermore, the first gNB 101 can directly communicate with any number of UEs and provide wireless broadband access to the network 130 for those UEs. Similarly, each of the second and third gNBs 102-103 can directly communicate with the network 130 and provide direct wireless broadband access to the network 130 for the UEs. In addition, the first through third gNBs 101, 102 and/or 103 can provide access to other or additional external networks, such as external telephone networks or other types of data networks.

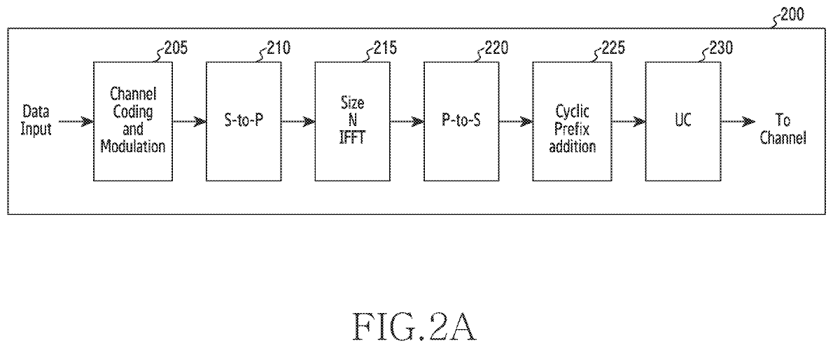

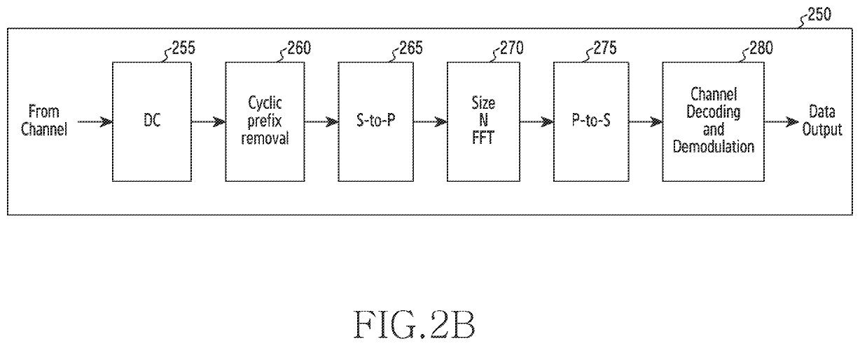

FIG. 2A is a diagram illustrating wireless transmission paths, according to an embodiment. In the following description, a transmission path 200 may be described as implemented in a gNB, such as the second gNB 102. However, it should be understood that the transmission path 200 may be implemented in a UE.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230.

In the transmission path 200, the channel coding and modulation block 205 receives a set of information bits, applies coding (e.g. LDPC coding), and modulates the input bits (e.g., using quadrature phase shift keying (QPSK) or quadrature amplitude modulation (QAM)) to generate a sequence of frequency-domain modulated symbols. The S-to-P block 210 converts (e.g., demultiplexes) serial modulated symbols into parallel data to generate N parallel symbol streams, where N is a size of the IFFT/FFT used in the second gNB 102 and the sixth UE 116. The size N IFFT block 215 performs IFFT operations on the N parallel symbol streams to generate a time-domain output signal. The P-to-S block 220 converts (e.g., multiplexes) parallel time-domain output symbols from the Size N IFFT block 215 to generate a serial time-domain signal. The cyclic prefix addition block 225 inserts a cyclic prefix into the time-domain signal. The UC 230 modulates (e.g., up-converts) the output of the cyclic prefix addition block 225 to an RF frequency for transmission via a wireless channel. The signal can also be filtered at a baseband before switching to the RF frequency.

FIG. 2B is a diagram illustrating wireless reception paths, according to an embodiment of the disclosure. In the following description, a reception path 250 may be described as implemented in a UE, such as the sixth UE 116. However, it should be understood that the reception path 250 may be implemented in a gNB. The reception path 250 may be configured to support codebook designs and structures for systems with 2D antenna arrays, as described herein.

The reception path 250 includes a down-converter (DC) 255, a cyclic prefix (CP) removal block 260, an S-to-P block 265, a size N fast Fourier transform (FFT) block 270, a P-to-S block 275, and a channel decoding and demodulation block 280.

The RF signal transmitted from the second gNB 102 arrives at the sixth UE 116 after passing through the wireless channel, and operations reverse to those at the second gNB 102 are performed at the sixth UE 116. The down-converter 255 down-converts the received signal to a baseband frequency, and the CP removal block 260 removes the CP to generate a serial time-domain baseband signal. The S-to-P block 265 converts the time-domain baseband signal into a parallel time-domain signal. The Size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of the first through third gNBs 101-103 may implement a transmission path 200 similar to that for transmitting to the first through sixth UEs 111-116 in the downlink, and may implement the reception path 250 similar to that for receiving from the first through sixth UEs 111-116 in the uplink. Similarly, each of the first through sixth UEs 111-116 may implement a transmission path 200 for transmitting to the first through third gNBs 101-103 in the uplink, and may implement a reception path 250 for receiving from the first through third gNBs 101-103 in the downlink.

Each of the components in FIGS. 2A and 2B may be implemented using only hardware, or using a combination of hardware and software/firmware. For example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete Fourier transform (DFT) and inverse discrete Fourier transform (IDFT) functions. For DFT and IDFT functions, the value of variable N may be any integer (e.g., 1, 2, 3, 4, etc.), while for FFT and IFFT functions, the value of variable N may be any integer which is a power of 2 (e.g., 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

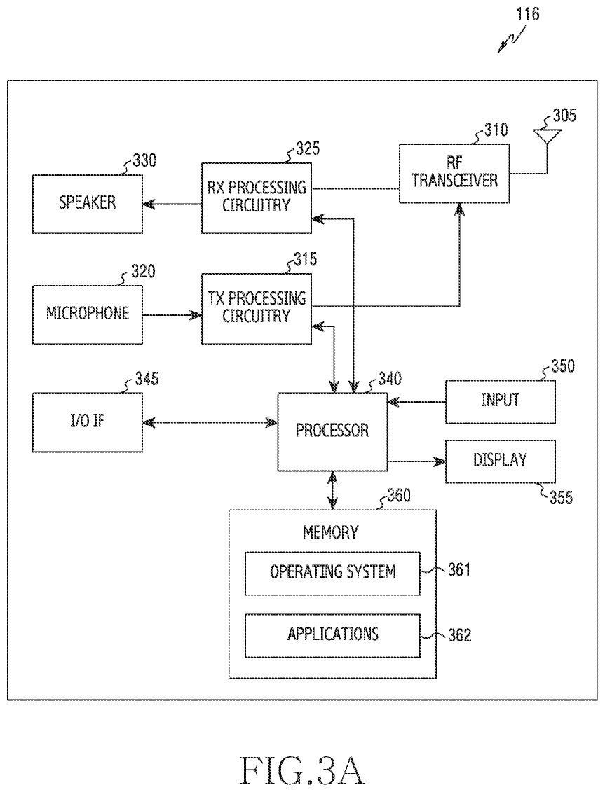

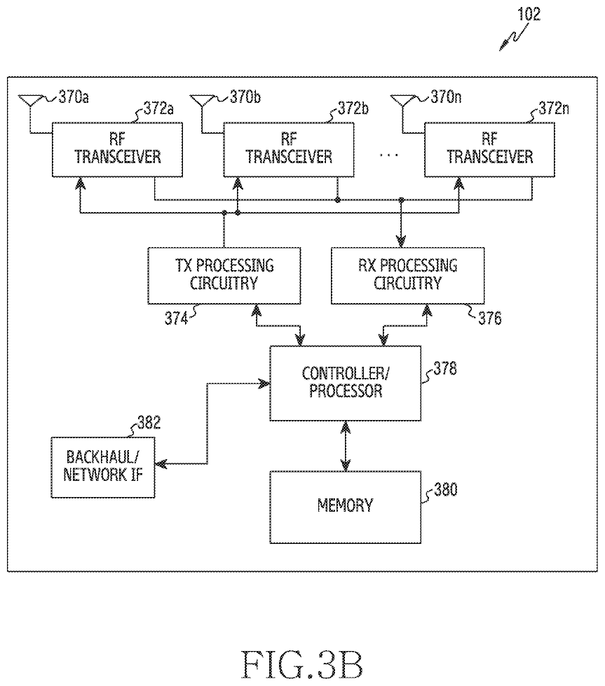

FIG. 3A is a diagram illustrating a UE according to an embodiment. The sixth UE 116 shown in FIG. 3A is for illustration only, and the first through fifth UEs 111-115 of FIG. 1 may have the same or similar configuration. However, a UE has various configurations, and FIG. 3A does not limit the scope of the disclosure to any specific implementation of the UE.

The sixth UE 116 includes an antenna 305, a radio frequency (RF) transceiver 310, a transmission (TX) processing circuit 315, a microphone 320, and a reception (RX) processing circuit 325. The sixth UE 116 also includes a speaker 330, a processor/controller 340, an input/output (I/O) interface 345, an input device(s) 350, a display 355, and a memory 360. The memory 360 includes an operating system (OS) 361 and one or more disclosures 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (e.g., for voice data) or to processor/controller 340 for further processing (e.g., for web browsing data).

The TX processing circuit 315 receives analog or digital voice data from microphone 320 or other outgoing baseband data (e.g., network data, email, or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute the OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. The processor/controller 340 may include at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. The processor/controller 340 is configured to execute the disclosure 362 based on the OS 361 or in response to signals received from the gNB or the operator. The processor/controller 340 is also coupled to an I/O interface 345, where the I/O interface 345 provides the sixth UE 116 with the capability to connect to other devices, such as laptop computers and handheld computers. The I/O interface 345 is a communication path between these accessories and the processor/controller 340.

The processor/controller 340 is also coupled to the input device(s) 350 and the display 355. An operator of the sixth UE 116 can input data into the sixth UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the sixth UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the sixth UE 116 is configured as a mobile phone or a smart phone, UEs can be configured to operate as other types of mobile or fixed devices.

FIG. 3B is a diagram illustrating a gNB, according to an embodiment. The second gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that the first gNB 101 and the third gNB 103 can include the same or similar structures as the second gNB 102.

As shown in FIG. 3B, the second gNB 102 includes a plurality of antennas 370a-370n, a plurality of RF transceivers 372a-372n, a TX processing circuit 374, and a RX processing circuit 376. One or more of the plurality of antennas 370a-370n may include a 2D antenna array. The second gNB 102 also includes a controller/processor 378, a memory 380, and a backhaul or network interface 382.

The RF transceivers 372a-372n receive an incoming RF signal from antennas 370a-370n, such as a signal transmitted by UEs or other gNBs. The RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to controller/processor 378 for further processing.

The TX processing circuit 374 receives analog or digital data (e.g., voice data, network data, email, or interactive video game data) from the controller/processor 378. The TX processing circuit 374 encodes, multiplexes and/or digitizes outgoing baseband data to generate a processed baseband or IF signal. The RF transceivers 372a-372n receive the outgoing processed baseband or IF signal from the TX processing circuit 374 and up-convert the baseband or IF signal into an RF signal transmitted via the antennas 370a-370n.

The controller/processor 378 may include one or more processors or other processing devices that control the overall operation of the second gNB 102. For example, the controller/processor 378 may control the reception of forward channel signals and the transmission of backward channel signals through the RF transceivers 372a-372n, the RX processing circuit 376, and the TX processing circuit 374 according to well-known principles. The controller/processor 378 may also support additional functions, such as higher-level wireless communication functions. For example, the controller/processor 378 may perform a blind interference sensing (BIS) process such as that performed through a BIS algorithm, and decode a received signal from which an interference signal is subtracted. The controller/processor 378 may support any of a variety of other functions in gNB 102. The controller/processor 378 may include at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays. The controller/processor 378 supports communication between entities such as web RTCs. The controller/processor 378 may move data into or out of the memory 380 as required by an execution process.

The controller/processor 378 is also coupled to the backhaul or network interface 382. The backhaul or network interface 382 allows the second gNB 102 to communicate with other devices or systems through a backhaul connection or through a network. The backhaul or network interface 382 may support communication over any suitable wired or wireless connection(s). For example, when the second gNB 102 is implemented as a part of a cellular communication system, such as a cellular communication system supporting 5G or new radio access technology or NR, LTE or LTE-A, the backhaul or network interface 382 may allow the second gNB 102 to communicate with other gNBs through wired or wireless backhaul connections. When the second gNB 102 is implemented as an access point, the backhaul or network interface 382 can allow the second gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in greater detail below, the transmission and reception paths of the second gNB 102 (implemented using the RF transceivers 372a-372n, the TX processing circuit 374, and/or the RX processing circuit 376) support aggregated communication with FDD cells and TDD cells.

Although FIG. 3B illustrates an example of the second gNB 102, various changes may be made to FIG. 3B. For example, the second gNB 102 can include any number of each component shown in FIG. 3A. As an example, the access point can include many backhaul or network interfaces 382, and the controller/processor 378 can support routing functions to route data between different network addresses. As another example, although shown as including a single instance of the TX processing circuit 374 and a single instance of the RX processing circuit 376, the second gNB 102 can include multiple instances of each (e.g., one for each RF transceiver).

Information configured by the base station, indicated by signaling, configured by the higher layer and pre-configured includes a set of configuration information. The information also includes multiple sets of configuration information from which the UE selects a set of configuration information to use according to predefined condition. The information further includes a set of configuration information containing a plurality of subsets from which the UE selects one subset to use according to predefined condition.

When referring to lower than a threshold, it may also be replaced by lower than or equal to a threshold. Higher than (exceeding) a threshold may also be replaced by higher than or equal to a threshold. Less than or equal to may also be replaced by less than, greater than, or equal to or greater than.

Some technical solutions provided herein are specifically described based on the V2X system, but its disclosure scenario should not be limited to the V2X system in sidelink communication, but can also be applied to other sidelink transmission systems. For example, the design based on the V2X sub-channel in the following embodiments can also be used for the device-to-device (D2D) sub-channel or other sub-channels of sidelink transmission. The V2X resource pool may also be replaced by a D2D resource pool in other sidelink transmission systems, such as D2D.

When the sidelink communication system is a V2X system, the terminal or UE may be a vehicle, an infrastructure, a pedestrian, and/or other types of terminals or UEs.

The base station may be replaced by other nodes, such as sidelink nodes. A specific example of a sidelink node is the roadside station (infrastructure) UE in the sidelink system. Any mechanism applicable to the base station may also be similarly used in the scenarios where the base station is replaced by other sidelink nodes. A base station in this specification can also be replaced by other nodes, such as sidelink nodes, a specific example is the roadside station (infrastructure) UE in the sidelink system. Any mechanism applicable to the base station in this embodiment can also be similarly used in the scenarios where the base station is replaced by other sidelink nodes, and the description will not be repeated.

A slot may be a subframe or slot in the physical sense, or a subframe or slot the logical sense. Specifically, the subframe or slot in the logical sense is the subframe or slot corresponding to the resource pool of sidelink communication. For example, in the V2X system, the resource pool is defined by a repeated bitmap, which is mapped to a specific set of slots, the specific set of slots can be all slots, or all other slots except some specific slots (e.g., slots for transmitting master information block (MIB)/system information block (SIB)). The slot indicated as “1” in the bitmap can be used for V2X transmission and belongs to the slot corresponding to the V2X resource pool. The slot indicated as “0” cannot be used for V2X transmission and does not belong to the slot corresponding to the V2X resource pool.

The following illustrates the difference between physical or logical subframes or slots. When calculating a time domain gap between two specific channels/messages (e.g., a physical shared sidelink channel (PSSCH) carrying sidelink data and a physical shared feedback channel (PSFCH) carrying corresponding feedback information), it is assumed that the gap is N slots. If physical subframes or slots are calculated, the N slots correspond to the absolute time length of N*x milliseconds in the time domain, and x is the time length of the physical slot (subframe) under the numerology of the scenario in millisecond. Otherwise, if the logical subframes or slots are calculated, take the sidelink resource pool defined by the bitmap as an example, the gap of the N slots corresponds to the N slots indicated as “1” in the bitmap, and the absolute time length of the gap changes with the specific configuration of the sidelink communication resource pool without a fixed value.

Further, the slot may be a complete slot or several symbols corresponding to sidelink communication in one slot. For example, when the sidelink communication is configured to be performed on the X1-X2 symbols of each slot, the slot in the following embodiment is the X1-X2 symbols in the slot in this scenario. Alternatively, when the sidelink communication is configured as mini-slot transmission, the slot in the following embodiments is mini-slot defined or configured in the sidelink system rather than the slot in the NR system. Alternatively, when the sidelink communication is configured as symbol level transmission, the slots in the following embodiments can be replaced with symbols, or can be replaced with N symbols with time domain granularity as symbol level transmission. The text and drawings are only provided as examples to help readers understand this disclosure. They are not intended and should not be construed to limit the scope of the present disclosure in any way. Although some embodiments and examples have been provided, based on the disclosure herein, it is obvious to those skilled in the art that changes can be made to the illustrated embodiments and examples without departing from the scope of this disclosure.

The sidelink communication based positioning technology can support UE-based positioning and UE-assisted positioning. UE-based positioning mainly involves UE transmitting or receiving positioning signal and collecting measurement result, and positioning at the UE based on the collected results. UE-assisted positioning mainly involves UE transmitting positioning signal, or measuring the positioning signal and reporting the measurement result to the network side, which completes the positioning of the UE. Accordingly, in the sidelink communication based positioning technology, there are several typical scenarios.

In a first scenario, the first UE transmits a signal/channel for positioning to the base station and/or other sidelink UEs through sidelink for measurement by the base station and/or other sidelink UEs. The measurement result may be reported to the network side or fed back to the first UE, and used to determine the location information of the first UE;

In a second scenario, the first UE transmits a signal/channel for positioning to the base station and/or other sidelink UEs through sidelink for measurement by the base station and/or other sidelink UEs. The measurement result may be reported to the network side or fed back to the first UE, and used to determine the location information of other UEs;

In a third scenario, the first UE receives the signal/channel for positioning transmitted by the base station and/or other sidelink UEs through sidelink and measures them. The measurement result may be reported to the network side or fed back to the base station and/or other sidelink UEs, and used to determine the location information of the first UE;

In a fourth scenario, the first UE receives the signals/channels for positioning transmitted by the base station and/or other sidelink UEs through sidelink and measures them. The measurement result may be reported to the network side or fed back to the base station and/or other sidelink UEs, and used to determine the location information of other UEs.

Herein, the method is provided for a UE to determine whether to transmit/receive positioning-related signal/channel through sidelink, and to determine the corresponding sidelink resources and transmit and receive positioning-related signals/channels on the resources.

Herein, a node can be at least one of a base station, a location management function (LMF), and a sidelink UE.

Herein, the reception of signals/channels (sidelink positioning reference signal (PRS)) for positioning can also be replaced by measurement, or replaced by reception and measurement.

A method is provided for the UE to determine resources for sidelink positioning signals.

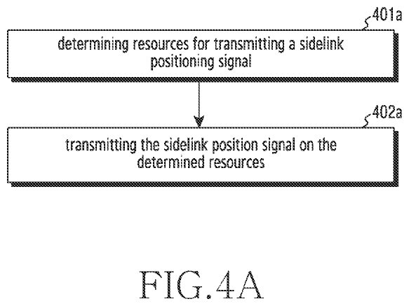

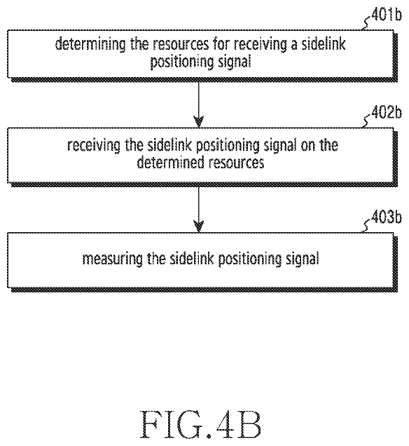

FIG. 4A is a flowchart illustrating a method, according to an embodiment.

At 401a, the UE determines resources for transmitting the sidelink positioning signal. Specifically, the UE determines resources for transmitting the sidelink positioning signal on the sidelink.

At 402a, the UE transmits the sidelink positioning signal on the determined resources.

FIG. 4B is a flowchart illustrating a method, according to another embodiment.

At 401b, the UE determines the resources for receiving the sidelink positioning signal. Specifically, the UE determines the resources for receiving the sidelink positioning signal on the sidelink.

At 402b, the UE receives the sidelink positioning signal on the determined resources.

At 403b, the UE measures the sidelink positioning signal.

The first UE may determine resources for transmitting and/or receiving the signal/channel for positioning on the sidelink, and may transit and/or receive the signal/channel for positioning on the resources.

For the convenience of description, the signal/channel for positioning are simply referred as SL PRS. Further, the signal/channel for positioning includes at least one of a PRS, a sounding reference signal (SRS), a PRS for sidelink, and configuration signaling related to positioning (which may be radio resource control (RRC)/media access control (MAC)/physical layer (PHY) signaling). The SRS for positioning is also referred to as SRS-Pos in the base station based positioning system. SRS is used to simplify the description.

herein, all types of signal/channel for positioning transmitted and/or received through sidelink are referred as SL PRS for short. Alternatively, PRS, SRS, and positioning reference signals for sidelink are all referred as SL PRS for short (i.e., the configuration signaling related to positioning is not considered as SL PRS). The two abbreviations can be used in the examples in this specification. The designation is mainly used to simplify the description and not to limit the scope of the disclosure.

The first UE determines resources for transmitting and/or receiving SL PRS on the sidelink, including the first UE obtaining at least one of the following information from a higher layer and/or other nodes, and determining the resources for transmitting and/or receiving SL PRS based on at least one of the following pieces of information.

First information of the resource pool for transmitting and/or receiving SL PRS, including at least one of resource pool index, time domain and/or frequency domain position of sidelink resources included in the resource pool, whether the resource pool can be used for transmitting data, and whether the resource pool can be used for transmitting SL PRS.

Second information of the resource set for transmitting and/or receiving SL PRS, including at least one of resource set ID, period, time domain offset, repetition factor, time interval (e.g., it can be similar to dl-PRS-ResourceTimeGap in the downlink positioning), mute configuration, resource list, comb size, bandwidth, start/end/used physical resource block (PRB), the number of symbol.

Third information of resources for transmitting and/or receiving SL PRS, including at least one of resource ID, sequence ID, comb size and offset, time domain offset (including offset of slots and/or symbols), and quasi-co-location (QCL) information.

The at least one piece of information can be obtained through RRC signaling and/or MAC signaling (e.g., MAC CE) and/or physical layer signaling (e.g., SCI formats).

The first UE determines resources for transmitting and/or receiving SL PRS on the sidelink, including determining resources and/or resource set for transmitting and/or receiving SL PRS based on at least one of:

(pre-)configured or (pre-)defined mapping rule;

the information indicated by the received SCI;

the received inter-UE coordination (IUC) information;

the information indicated in the request signaling when the first UE is triggered by the request signaling to transmit and/or receive SL PRS; and

channel sensing.

For determining the resources for transmitting and/or receiving SL PRS on the sidelink based on (pre-)configured or (pre-)defined mapping rule, alternatively, the first UE uses at least one of the first UE obtains information of at least one resource set and/or at least one resource in the configuration of the resource pool or transmitting and/or receiving SL PRS, the first UE obtains information of at least one resource set and/or at least one resource for transmitting and/or receiving SL PRS in UE-specific configuration signaling, and the first UE obtains information of at least one resource set and/or at least one resource for transmitting and/or receiving SL PRS in signaling indicated by other UEs, including SCI and/or request signaling for triggering the first UE to transmit and/or receive SL PRS.

For the first UE to obtain information of at least one resource set and/or at least one resource to determine resources for transmitting SL PRS, alternatively, the first UE uses at least one of the following:

when the first UE obtains one resource set, it selects resources for transmitting SL PRS from the resource set;

when the first UE obtains one resource, it transmits the SL PRS on the resource;

when the first UE obtains a plurality of resource sets, it selects at least one resource set from the plurality of resource sets for transmitting SL PRS according to the (pre-)configured or (pre-)defined mapping rule and/or based on specific parameters; and

when the first UE obtains a plurality of resources in one or more resource sets, it selects at least one resource from the plurality of resources for transmitting SL PRS according to the (pre-)configured or (pre-)defined mapping rule.

Alternatively, the resource sets and/or resources are resource sets and/or resources that can be used by the first UE; for example, if the configuration of the resource pool obtained by the first UE includes M resource sets, but only N resource sets are configured for the first UE, the resource sets in the above method are the N resource sets. Alternatively, the resource sets and/or resources are resource sets and/or resources that can be used by the first UE and other UEs. For example, if the configuration of the resource pool obtained by the first UE includes M resource sets, the multiple resource sets in the above method are the M resource sets. The selection by the first UE between the two methods can be (pre-)configured or (pre-)defined.

The first UE selects resources from one resource set, and/or selects one resource set from a plurality of resource sets, and/or selects at least one resource from a plurality of resources, and/or selects a resource set available for the first UE from among the resource sets included in the configuration of the resource pool based on specific parameters. The specific parameters include at least one of the following: priority, index and/or offset of SL PRS configured by higher layer/base station/LMF/the second UE, identity of the first UE (including the source ID corresponding to SL PRS, the ID of the first UE, the group ID of the UE group to which the first UE belongs, the intra-group ID/index/serial number of the first UE in a UE group), identity of the second UE (including the destination ID corresponding to the SL PRS, the ID of the second UE, the group ID of the UE group to which the second UE belongs, the intra-group ID/index/serial number of the second UE in a UE group), the geographical location of the first UE (including the zone ID of the first UE), and the geographical location of the second UE (including the zone ID of the second UE). The second UE includes the UE that the first UE expects to receive the SL PRS and/or the UE indicated by the destination ID corresponding to the SL PRS transmitted by the first UE. For example, when the first UE is triggered by the request signaling to transmit SL PRS, the second UE may be the UE that transmits the request signaling and/or the UE that will receive the SL PRS indicated in the request signaling.

In a specific example, the first UE obtains a total of N resource sets in the resource pool configuration, and selects at least one of them for transmitting SL PRS according to specific parameters. Alternatively, if the N resource sets correspond to priorities, for example, the priorities {1, 2, 3, 4} {5, 6, 7, 8} correspond to two subsets of the resource sets respectively, the first UE selects the transmission resources of the SL PRS in the subset corresponding to the priority of the transmitted SL PRS. Alternatively, if the N resource sets correspond to geographical locations, for example, the N resource sets are further divided into k subsets, the first UE selects transmission resources in the kl-th subset according to its zone ID mod k=k1. Alternatively, if the first UE selects transmission resources from a total of N resource sets (which can be the above total N resource sets or any subsets), selects the resource set with a serial number equals to UE ID mod n for transmitting SL PRS. Similarly, the UE can also select resource set with a serial number equals to (UE ID* priority) mod n, (UE ID+ region ID) mod n, etc. for transmitting SL PRS. The UE ID can be the ID of the first UE (or the source ID corresponding to the SL PRS), the ID of the second UE (or the destination ID corresponding to the SL PRS) or the sum of both.

For the first UE to obtain information of at least one resource set and/or at least one resource to determine resources for receiving SL PRS, alternatively, the first UE uses at least one of the following:

when the first UE obtains one resource set, it selects resources for receiving SL PRS from the resource sets;

when the first UE obtains one resource, it receives the SL PRS on the resource;

when the first UE obtains a plurality of resource sets, it selects at least one resource set from the plurality of resource sets for receiving SL PRS according to the (pre-)configured or (pre-)defined mapping rule and/or based on specific parameters;

when the first UE obtains a plurality of resources in one or more resource sets, it selects at least one resource from the plurality of resource sets for receiving SL PRS according to the (pre-)configured or (pre-)defined mapping rule;

when the first UE obtains multiple resource sets and/or multiple resources, it receives SL PRS on all resource sets and/or all resources; and

the first UE receives the SL PRS on all resource sets and/or all resources in a resource pool for receiving the SL PRS.

Specifically, the method used by the first UE includes the method that can be used when the first UE obtains the information of at least one resource set and/or at least one resource to determine the resources for transmitting the SL PRS, and the description will not be repeated here. In addition, the method used by the first UE may further include: the first UE determines at least one second UE, the second UE will transmit SL PRS to the first UE; the first UE obtains the information of resource set and/or resources used by the second UE to transmit SL PRS; based on the information, the first UE receives the SL PRS on the resource se and/or resources used by the second UE to transmit the SL PRS. When the first UE determines that there are more than one second UE, the first UE receives the SL PRS on the union of resource sets and/or resources used by each second UE to transmit the SL PRS. The first UE obtaining the information of the resource set and/or resources used by the second UE to transmit SL PRS includes obtaining the information corresponding to the second UE by using a method similar to the first UE obtaining the information of the resource set and/or resources used by itself to transmit SL PRS, and also includes obtaining the information of the resource set and/or resources used by the second UE to transmit SL PRS that the second UE indicates to the first UE. Further, the second UE may indicate the information to the first UE through SCI, the SCI includes SCI associated with SL PRS and/or SCI of scheduling data; and/or, if the first UE is triggered by the request signaling to transmit and/or receive the SL PRS, the information may be indicated by the second UE to the first UE in the request signaling.

Alternatively, to determine the resources for transmitting and/or receiving SL PRS based on the received information indicated by the SCI and/or the received inter-UE coordination information, the first UE may use at least one of the following.

The first UE receives SCI indicating SL PRS resources. The indication may be understood as that the SCI reserves the resources for future. The first UE considers that the SCI indicates the resources reserved by the second UE for the first UE, and transmits the SL PRS on the resources indicated by the SCI; or, the first UE considers that the SCI indicates the resources reserved by the second UE for itself, and transmits the SL PRS on the other resources except the resources indicated by the SCI. Whether the resources indicated in the SCI belong to the resources reserved for the first UE can be explicitly indicated in the SCI, or determined according to at least one of SCI formats, specific values of domains in the SCI, and higher layer configuration.

The first UE receives SCI indicating SL PRS resources. The indication may be understood as that the SCI reserves the resources for future. The first UE considers that the SCI indicates the resources reserved by the second UE for the first UE, and receives the SL PRS on the resources indicated by the SCI; or, the first UE considers that the SCI indicates the resources reserved by the second UE for itself, and receives the SL PRS on the other resources except the resources indicated by the SCI. Whether the resources indicated in the SCI belong to the resources reserved for the first UE can be explicitly indicated in the SCI, or determined according to at least one of SCI formats, specific values of domains in the SCI, and higher layer configuration.

The first UE receives inter-UE coordination information indicating information related to SL PRS, including resources available for the first UE to transmit SL PRS. The first UE transmits SL PRS on the resource indicated by the inter-UE coordination information;

The first UE receives inter-UE coordination information indicating information related to SL PRS, including resources available for the first UE to receive SL PRS. The first UE receives the SL PRS on the resource indicated by the inter-UE coordination information. Alternatively, the inter-UE coordination information is transmitted to the second UE by the third UE, which indicates that the second UE transmits the information related to SL PRS to the first UE, that is, the first UE receives the information related to SL PRS from the second UE.

The resources in the method described above may also be replaced by resource sets.

Alternatively, the method is used when the resource pool is configured to be available for SL PRS only, and/or when (the resource pool is configured to be) SL PRS cannot be multiplexed on control and/or data channel.

Alternatively, to determine the resources for transmitting and/or receiving SL PRS based on the information indicated by the received SCI and/or the received inter-UE coordination information, the first UE may also use at least one of the following.

The first UE receives SCI from the second UE, the SCI and/or the PSSCH associated with the SCI indicates the information related to SL PRS, and the SCI also indicates resources for future in the same resource pool, specifically, SL PRS resources for future and/or PSSCH resources for future. The indication can be understood as that the SCI reserves the resources for future. The first UE considers that the SCI indicates the resources reserved by the second UE for the first UE, and transmits the SL PRS on the SL PRS resources and/or PSSCH resources indicated by the SCI; or, the first UE considers that the SCI indicates the resources reserved by the second UE for itself, and transmits the SL PRS on the other resources except the SL PRS resources and/or PSSCH resources indicated by the SCI. Alternatively, the first UE transmitting the SL PRS on the PSSCH resources includes: the first UE transmitting the SL PRS and the PSSCH on the PSSCH resources, and multiplexing the SL PRS on the PSSCH; or, the first UE transmitting the SL PRS on the PSSCH resources and not transmitting the PSSCH. Whether the resources indicated in the SCI belong to the resources reserved for the first UE can be explicitly indicated in the SCI, or determined according to at least one of SCI formats, specific values of domains in the SCI, and higher layer configuration.

The first UE receives an SCI from the second UE, the SCI, and/or the PSSCH associated with the SCI indicates the information related to SL PRS, and the SCI also indicates resources for future in the same resource pool, specifically, SL PRS resources for future and/or PSSCH resources for future, and also indicates that SL PRS is multiplexed on the PSSCH. The indication can be understood as that the SCI reserves the resources for future. The first UE considers that the SCI indicates the resources reserved by the second UE for the first UE, and receives the SL PRS on the SL PRS resources and/or PSSCH resources indicated by the SCI; or, the first UE considers that the SCI indicates the resources reserved by the second UE for itself, and receives the SL PRS on the other resources except the SL PRS resources and/or PSSCH resources indicated by the SCI. Whether the resources indicated in the SCI belong to the resources reserved for the first UE can be explicitly indicated in the SCI, or determined according to at least one of SCI formats, specific values of domains in the SCI, and higher layer configuration.

The first UE receives inter-UE coordination information indicating information related to SL PRS, including resources available for the first UE to transmit SL PRS, and/or resources available for the first UE to transmit PSSCH, and also indicating that the SL PRS can be multiplexed on the PSSCH. The first UE transmits the SL PRS on the above SL PRS resource and/or PSSCH resources indicated by the inter-UE coordination information.

The first UE receives inter-UE coordination information indicating information related to SL PRS, including resources available for the first UE to receive SL PRS, and/or indicating resources available for the first UE to receive PSSCH and also indicating that SL PRS can be multiplexed on PSSCH. The first UE receives the SL PRS on the SL PRS resource and/or PSSCH resources indicated by the inter-UE coordination information. Alternatively, the inter-UE coordination information is transmitted to the second UE by the third UE, which indicates that the second UE transmits the information related to SL PRS to the first UE, that is, the first UE receives the information related to SL PRS from the second UE.

The resources described above may also be replaced by resource sets. Alternatively, the UE determines one resource and/or resource set through the above method, and transmits and/or receives the SL PRS on the resource and/or resource set. Alternatively, the UE determines a plurality of resources and/or resource sets through the above method, and further selects resource and/or resource set among the plurality of resources and/or resource sets (e.g., based on (pre-)configured or (pre-)defined mapping rule, the specific method is similar to the above), and transmits and/or receives SL PRS on the selected resource and/or resource set.

Alternatively, the above method is used when the resource pool is configured to be available for SL PRS and data, and/or when (the resource pool is configured to be) SL PRS can be multiplexed on control and/or data channels (i.e., PSCCH and/or PSSCH).

Alternatively, to determine resources for transmitting and/or receiving SL PRS based on the information indicated in the request signaling, the first UE uses at least one of the following.

The first UE receives the request signaling from the second UE or the base station. The signaling indicates that the first UE receives SL PRS (optionally from the second UE), and indicates resources for the first UE to receive SL PRS, and/or resources for the second UE to transmit SL PRS. The first UE receives the SL PRS on the resource. Alternatively, the resources indicated in the signaling for the first UE to receive the SL PRS and/or for the second UE to transmit the SL PRS include resources for the SL PRS and/or PSSCH resources. Alternatively, the request signaling indicates that the SL PRS is multiplexed on the PSSCH.

The first UE receives the request signaling from the second UE or the base station. The signaling indicates that the first UE transmits SL PRS (optionally to the second UE), and indicates resources for the first UE to transmit SL PRS, and/or resources for the second UE to receive SL PRS. The first UE transmits SL PRS on the resource. Alternatively, the resources indicated in the signaling for the first UE to transmit the SL PRS and/or for the second UE to receive the SL PRS include resources for the SL PRS and/or PSSCH resources. Alternatively, the request signaling indicates that the SL PRS is multiplexed on the PSSCH.

The resources described above may also be replaced by resource sets. Alternatively, the UE determines one resource and/or resource set through the above method, and transmits and/or receives the SL PRS on the resource and/or resource set. Alternatively, the UE determines a plurality of resources and/or resource sets through the above method, and further selects a resource and/or resource set among the plurality of resources and/or resource sets (e.g., based on (pre-)configured or (pre-)defined mapping rule, the specific method is similar to the above), and transmits and/or receives SL PRS on the selected resource and/or resource set.

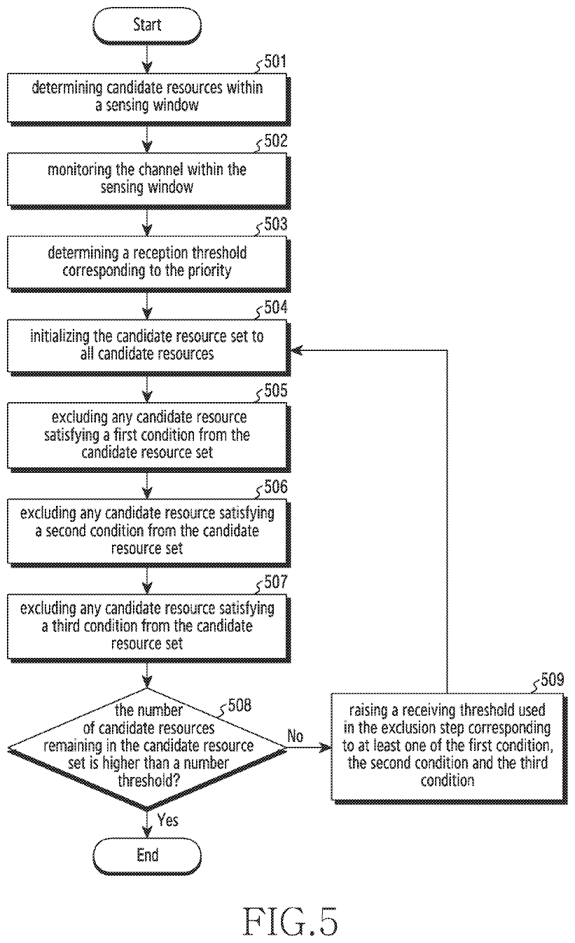

FIG. 5 is a flowchart illustrating a method of determining the resources for transmitting sidelink positioning signals based on channel sensing, according to an embodiment. For determining the resources for transmitting SL PRS based on channel sensing, alternatively, the first UE uses the following method, wherein each step is an optional step.

At 501, the first UE performs sensing to determine resources for transmitting SL PRS, and obtains parameters related to sensing from the higher layer; or the first UE obtains parameters related to sensing provided by the higher layer, the parameters are used to trigger the first UE to perform sensing to determine resources for transmitting SL PRS.

The first UE determines candidate resources within the resource sensing window [n+T1, n+T2], and the candidate resources include at least one of the following: each resource with granularity of L subchannels consecutive or interleaved in frequency domain and J slots consecutive or interleaved in time domain within [n+T1, n+T2], wherein when the SL PRS is multiplexed on data, L and J can be the size of resource corresponding to data, otherwise, when SL PRS is not multiplexed on data, L and J can be the size of resource corresponding to one transmission of SL PRS; each (pre-)configured resource set within [n+T1, n+T2] can be identified by the index of the resource set; each SL PRS resource in the (pre-)configured resource set within [n+T1, n+T2] can be identified by the index of the resource; each (pre-)configured SL PRS pattern within [n+T1, n+T2].

At 502, the first UE monitors the channel within a sensing window. The sensing window includes a time window [n−a, n−b] before the a specific time reference point slot n, and/or a periodic sensing opportunity [n-period*k, n-period*k+R] before the slot n. The time reference point includes at least one of the following: the time point when the first UE is triggered to perform sensing to determine the resources for transmitting SL PRS, the slot where at least one candidate resource is located, and the slot where the earliest candidate resource is located. The values of a and b are (pre-)configured/(pre-)defined. The meaning of period in physical is the period of SL PRS and/or the period of sidelink data, which can be a set of periods configured by higher layer parameters, for example, the set of periods of SL PRS indicated in the resource pool configuration or a subset thereof, and/or the set of periods configured in the higher layer parameter sl-ResourceReservePeriodList. The meaning of k in physical is the order of period of SL PRS and/or sidelink data, and its values include a set of positive integers, and the values in the set can be configured by the base station/higher layer, for example, the meaning of k={1, 2, 3} in physical is the sensing opportunity corresponding to the periods of the last 1st, 2nd and 3rd SL PRS. For a value ki included in k, [n-period*ki, n-period*ki+R] is a time window with a length of R+1, and [n-period*k, n-period*k+R] is i time windows with a length of R+1 corresponding to a total of i values of k. Wherein R is a non-negative integer, and its meaning in physical can be the number of repetitions of SL PRS or the number of slots used for one SL PRS transmission;

At 503, the first UE determines a corresponding to at least one of the priority of transmitted SL PRS, the priority of received SL PRS, the priority of transmitted data and the priority of received data, the reception threshold includes at least one of RSRP threshold, RSSI threshold and received power threshold.

At 504, the first UE initializes the candidate resource sets SA as all candidate resources.

At 505, the first UE excludes any candidate resource from the SA if the candidate resource lacks the corresponding monitoring result, and further, if the candidate resource satisfies the following first conditions: the UE does not have monitoring slot t′ₘ^{SL} in the sensing window; and for the value of the period of any SL PRS and/or sidelink data (which may be the period value configured in the specific high-layer parameters corresponding to the sensing process for determining SL PRS; for convenience of description, this value is called p), when the value of the resource reservation period domain indicated by an assumed SCI formats on a slot t′ₘ^{SL} is set to the value of this period (i.e., p) and indicates all sub-channels on the resource pool and/or all configured comb sizes and/or offsets, and alternatively all possible values of at least one of time domain offset, repetition factor and time interval, the following second condition and/or third condition can be satisfied; if the number of excluded candidate resources is lower than a threshold, the first UE initializes the candidate resource sets SA as all the candidate resources (before the exclusion in this step).

At 506, the first UE excludes any candidate resource from the SA if the candidate resource will conflict with the data resources reserved by other UEs potentially, further, if the candidate resource satisfies all the following second conditions: a) the first UE receives an SCI formats in a slot t′ₘ^{SL}, and the SCI formats indicates the period and priority of data; b) the RSRP measurement result is higher than the receiving threshold determined according to the priority; c) the corresponding position of the resource indicated by the SCI formats after several periods coincides with the candidate resource or with the corresponding position of the candidate resource after several periods.

At step 507, the first UE excludes any candidate resource from the S if the candidate resource will conflict with SL PRS resources reserved by other UEs potentially, further, if the candidate resource satisfies all the following third conditions: a) the first UE receives an SCI formats on the slot t′ₘ^{SL}, and the SCI formats indicates the period and priority of SL PRS; and/or, the first UE detects an SL PRS on the slot t′ₘ^{SL}; b) the RSRP measurement result is higher than the receiving threshold determined according to the priority; and c) the resource location occupied by the pattern corresponding to the SL PRS in the current period, at least one resource location of the resource locations occupied by the pattern corresponding to the SL PRS after one or more periods overlap with the resource location occupied by the candidate resource, the resource location occupied by the pattern corresponding to the candidate resource in the current period and the at least one resource location if the resource locations occupied by the pattern corresponding to the candidate resource after one or more periods.

At 508, the first UE determines whether the number of candidate resources remaining in the candidate resource set is higher than a number threshold. When the number of candidate resources remaining in the candidate resource set is higher than a number threshold, the method performed by the UE is ended.

At 509, when the number of candidate resources remaining in SA after exclusion is lower than the (pre-)configured/(pre-)defined number threshold, the receiving threshold used in the exclusion step corresponding to at least one of the first condition, the second condition and the third condition is increased, and the process is repeated until the number of candidate resources remaining in SA after exclusion is higher than or equal to the (pre-)configured/(pre-)defined number threshold.

Alternatively, in the above-described method, only when the resource pool can be used to transmit the SL PRS and sidelink data and/or the SL PRS can be multiplexed on the PSSCH, parameters related to the sidelink data (e.g., the period of the sidelink data) can be used; otherwise, when the resource pool can only be used to transmit the SL PRS and/or the SL PRS cannot be multiplexed on the PSSCH, the parameters related to the sidelink data are not used, and only the parameters related to the SL PRS are used.

Alternatively, in the above-described third condition, when the first UE detects one SL PRS, it determines the pattern (further including comb size, time domain length such as the number of OFDM symbols, RE offset and the relationship between these parameters), period, time domain offset, priority and other parameters corresponding to the SL PRS according to the (pre-)configured/(pre-)defined rule; and/or, if SCI or other control signaling (such as RRC signaling or physical layer signaling similar to wake-up signal sequence) corresponding to the SL PRS is detected, according to the information in the SCI or other control signaling, parameters such as pattern, period, time domain offset, priority and the like corresponding to the SL PRS are determined.

In the above-described method, the order in which each step is explained does not represent the sequence in which the UE performs the step. For example, the time range of the sensing window may be earlier than the time range of the slot n earlier than the RSW, that is, the UE monitors the channel on the sensing window first, then is triggered to determine the resources for transmitting the SL PRS based on the channel sensing in the slot n, and then selects the resources for transmitting the SL PRS within the RSW.

Among the above-mentioned SCI reception based method, inter-UE coordination based method, request signaling based method, and channel sensing based method, alternatively, if the first UE determines that SL PRS is multiplexed on PSSCH based on the information indicated in at least one of SCI, inter-UE coordination information, and request signaling, and/or based on the configuration of the higher layer or base station, and/or based on predefined rule, the first UE may determine SL PRS resources and/or PSSCH resources for transmitting and/or receiving SL PRS, and may transmit and/or receive SL PRS on the determined PSSCH resources. Alternatively, if the first UE determines that the SL PRS cannot be multiplexed on the PSSCH based on the information indicated in at least one of SCI, inter-UE coordination information and request signaling, and/or based on the configuration of the higher layer or base station, and/or based on predefined rule, the first UE will not determine the PS SCH resources for transmitting and/or receiving the SL PRS, and will not transmit and/or receive the SL PRS on the determined PSSCH resources.

The first UE determines the resources for transmitting and/or receiving the SL PRS on the sidelink, and transmits and/or receives the SL PRS on the resources, further includes at least one of the following:

The UE determines the resources used by the SCI associated with the SL PRS, and transmits and/or receives the SCI on the resources used by the SCI;

The UE determines the resources for transmitting and/or receiving the SL PRS, and transmits and/or receives the SL PRS and the SCI associated with the SL PRS on the resources.

For the above-described case of determining the resources for transmitting and/or receiving SL PRS and transmitting and/or receiving SL PRS and SCI associated with the SL PRS on the resources, alternatively, the position of the resources used by SCI in the resources for transmitting and/or receiving SL PRS is determined according to (pre-)configured/(pre-)defined rule.

The first UE transmits the SCI associated with the SL PRS, and further includes at least one of the following:

indicating the resource location used by the associated SL PRS in SCI;

indicating the subsequent other resource locations to be used by SL PRS in SCI;

indicating information of the resource sets used by the associated SL PRS in SCI;

indicating information of the subsequent other resource sets to be used by SL PRS in SCI, the information includes at least one of the following: resource set ID, period, time domain offset, repetition factor, time interval (e.g., it can be similar to dl-PRS-ResourceTimeGap in downlink positioning), mute configuration, resource list, comb size, bandwidth, start/end/PRB used, the number of symbol;

indicating information of the resources used by the associated SL PRS in SCI; and

indicating information of the subsequent other resources to be used by SL PRS in SCI, the information includes at least one of the following: resource ID, sequence ID, comb size and offset, time domain offset (including offset of slot and/or symbol), and QCL information.

When the first UE transmits the SCI associated with the SL PRS, it needs to generate the information indicated in the SCI according to the location of the resources to be used for transmitting the SL PRS. On the contrary, when the first UE receives the SCI associated with the SL PRS, it needs to use the information indicated in the SCI to determine the location of the resources to be used for receiving the SL PRS. The generation/usage of the information indicated in the SCI specifically includes information indicated in the SCI generated/used by the first UE according to at least one of the following. The logical period is a period calculated by logical subframe, and the logical subframe is the subframe configured for the resource pool.

The SCI indicates the resource location of SL PRS in the same resource pool as the SCI. The period indicated by the SCI is based on physical period or logical period, and the time domain offset indicated by the SCI is based on logical subframe. The frequency domain resource location indicated by the SCI is based on the frequency domain resources allocated to the resource pool. Alternatively, the above-described method is used when the resource pool is configured to be available for SL PRS and data, and/or when (the resource pool is configured to be) the SL PRS can be multiplexed on control and/or data channels, and/or when the resource pool is configured to be available for at least SL PRS and there are PSCCH resources in the resource pool for transmitting SCI.

The SCI indicates the resource location of PSSCH in the same resource pool as the SCI. The SCI also indicates the location of SL PRS in the resources used by the PSSCH based on the resource location of the PSSCH, and/or there is a (pre-)configured/(pre-)defined resource mapping relationship between the SL PRS and the PSSCH. Alternatively, the above method is used when the resource pool is configured to be available for SL PRS and data, and/or when (the resource pool is configured to be) the SL PRS can be multiplexed on the control and/or data channels.

The SCI indicates the resource location of SL PRS in a different resource pool with the SCI, and the resource pool where the SCI is located is referred as the first resource pool and the resource pool where the SL PRS is located is referred as the second resource pool. The period indicated by the SCI is based on the physical period, or the period indicated by the SCI is based on the logical period of the first resource pool, or the period indicated by the SCI is based on the logical period of the second resource pool. The time domain offset indicated by the SCI is based on the logical subframe of the first resource pool, or the time domain offset indicated by the SCI is based on the logical subframe of the second resource pool. The frequency domain resource location indicated by the SCI is based on the frequency domain resource of the first resource pool (e.g., the sub-channel sequence number in the first resource pool), or the frequency domain resource location indicated by the SCI is based on the frequency domain resource of the second resource pool, or the frequency domain resource location indicated by the SCI is the physical location of the frequency domain resource (e.g., RB index). Alternatively, when the SCI indicates the period and time-domain offset based on the first resource pool, the indicated time-domain position (or time-domain starting position, when the SL PRS occupies multiple slots and/or OFDM symbols) of the SL PRS is the earliest slot and/or OFDM symbol allocated to the second resource pool starting from the slot and/or OFDM symbol calculated according to the period and time-domain offset in the first resource pool. Alternatively, when the SCI indicates the period and time-domain offset based on the second resource pool, the time-domain reference point corresponding to the offset (e.g., if the offset indicated by the SCI is a, the time-domain position of SL PRS is n+a, and n is the time-domain reference point) is the earliest slot and/or OFDM symbol allocated to the second resource pool starting from the slot and/or OFDM symbol where the SCI ends. The method does not limit whether the resource pool can be used for data, and does not limit whether the SL PRS can be multiplexed on the control and/or data channel;

The SCI indicates parameters of SL PRS, such as physical quantity-based period (e.g., millisecond), time-domain offset, frequency-domain position (e.g., RB index). The method does not limit whether the SL PRS has a corresponding resource pool.

An electronic device of the disclosure includes a memory configured to store a computer program, and a processor configured to read the computer program from the memory and execute the computer program to implement the above method.

The term “module” may refer to a unit including one of hardware, software, firmware, or a combination thereof. The term “module” can be used interchangeably with the terms “unit”, “logic”, “logic block”, “component” and “circuit”. The term “module” can indicate the smallest unit or part of an integrated component. The term “module” may indicate the smallest unit or part that performs one or more functions. The term “module” means a device that can be implemented mechanically or electronically. For example, the term “module” may indicate a device including at least one of a disclosure specific integrated circuit (ASIC), a field programmable gate array (FPGA) or a programmable logic array (PLA) that performs certain operations that are known or will be developed in the future.

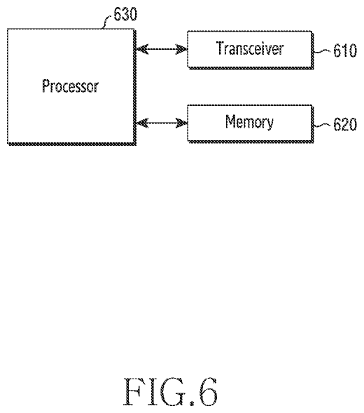

FIG. 6 is a block diagram illustrating a UE, according to an embodiment. Furthermore, the UE may correspond to the sixth UE 116 of FIG. 1 and FIG. 3A.

As shown in FIG. 6, the UE may include a transceiver 610, a memory 620, and a processor 630. The transceiver 610, the memory 620, and the processor 630 of the UE may operate according to a communication method of the UE described above. However, the components of the UE are not limited thereto. For example, the UE may include more or fewer components than those described above. In addition, the processor 630, the transceiver 610, and the memory 620 may be implemented as a single chip. Also, the processor 630 may include at least one processor.

The transceiver 610 collectively refers to a UE receiver and a UE transmitter, and may transmit/receive a signal to/from a base station or a network entity. The signal transmitted or received to or from the base station or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as ROM, RAM, a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

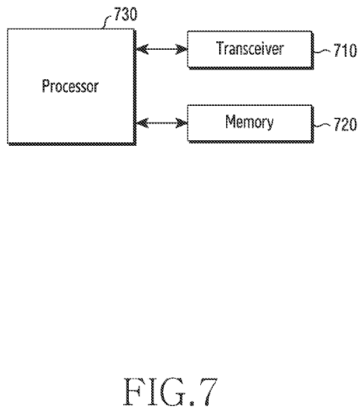

FIG. 7 is a block diagram illustrating a base station, according to an embodiment. Furthermore, the base station may correspond to base station 116 of FIG. 1 and FIG. 3B.

As shown in FIG. 7, the base station according to an embodiment may include a transceiver 710, a memory 720, and a processor 730. The transceiver 710, the memory 720, and the processor 730 of the base station may operate according to a communication method of the base station described above. However, the components of the base station are not limited thereto. For example, the base station may include more or fewer components than those described above. In addition, the processor 730, the transceiver 710, and the memory 720 may be implemented as a single chip. Also, the processor 730 may include at least one processor.

The transceiver 710 collectively refers to a base station receiver and a base station transmitter, and may transmit/receive a signal to/from a terminal or a network entity. The signal transmitted or received to or from the terminal or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the base station. Also, the memory 720 may store control information or data included in a signal obtained by the base station. The memory 720 may be a storage medium, such as ROM, RAM, a hard disk, a CD-ROM, and a DVD, or a combination of storage media.

The processor 730 may control a series of processes such that the base station operates as described above. For example, the transceiver 710 may receive a data signal including a control signal transmitted by the terminal, and the processor 730 may determine a result of receiving the control signal and the data signal transmitted by the terminal.

At least a part of a device (e.g., a module or its function) or a method (e.g., an operation) can be implemented as instructions stored in a non-transitory computer-readable storage medium, for example, in the form of a programmed circuit. When performed by a processor, the instructions can enable the processor to perform corresponding functions. The non-transitory computer-readable storage medium may be, for example, a memory.

Non-transitory computer-readable storage media may include hardware devices such as hard disks, floppy disks, and magnetic tapes (e.g., magnetic tapes), optical media such as compact disk ROM (CD-ROM) and digital versatile disk (DVD), magneto-optical media such as compact disks, ROM, RAM, flash memory, etc. Examples of programs can include not only machine language codes but also high-level language codes that can be executed by various computing devices using interpreters. The above-described hardware devices can be configured to operate as one or more software modules to execute the embodiments of the present disclosure, and vice versa.

Circuits or programming circuits may include at least one or more of the components, omit some of them, or also include other additional components. Operations performed by circuits, programmed circuits, or other components according to various embodiments of the present disclosure may be performed sequentially, simultaneously, repeatedly, or heuristically. In addition, some operations may be performed in a different order, or omitted, or include other additional operations.

The embodiments of the present disclosure are described to facilitate understanding of the disclosure, but are not intended to limit the scope of the disclosure. Therefore, the scope of the disclosure should be interpreted to include all changes or various embodiments based on the scope of the present disclosure defined by the appended claims and their equivalents.

What is claimed is:

1. A method performed by a node device in a communication system, the method comprising:
determining resources for transmitting a sidelink positioning signal; and
transmitting the sidelink positioning signal on the determined resources;
wherein determining the resources for transmitting the sidelink positioning signal comprises at least one of:
determining the resources for transmitting the sidelink positioning signal based on at least one of a mapping rule and specific parameters;
determining the resources for transmitting the sidelink positioning signal based on information indicated by received first sidelink control information (SCI);
determining the resources for transmitting the sidelink positioning signal based on received inter-node coordination information;
determining the resources for transmitting the sidelink positioning signal based on information indicated in request signaling if triggered by the request signaling to transmit the sidelink positioning signal; and
determining the resources for transmitting the sidelink positioning signal based on channel sensing.

2. The method of claim 1, further comprising obtaining, from a higher layer or other nodes, at least one of:
first information of a resource pool for transmitting the sidelink positioning signal;
second information of a resource set for transmitting the sidelink positioning signal; and
third information of resources for transmitting the sidelink positioning signal.

3. The method of claim 1, wherein determining the sidelink positioning signal is multiplexed on a physical sidelink shared channel (PSSCH) based on at least one of the information indicated by the received first SCI, the inter-node coordination information, the request signaling, a configuration of a higher layer or a base station, and a predefined rule.

4. The method of claim 1, wherein determining the resources for transmitting the sidelink positioning signal based on at least one of the mapping rule and specific parameters comprises at least one of:
obtaining a plurality of resource sets, and determining at least one resource set among the plurality of resource sets for transmitting the sidelink positioning signal based on the at least one of the mapping rule and specific parameters; and
obtaining a plurality of resources in one or more resource sets, and determining at least one resource among the plurality of resources for transmitting the sidelink positioning signal based on the mapping rule.

5. The method of claim 4, wherein determining the at least one resource set or the at least one resource comprises at least one of:
obtaining information of a resource pool for transmitting the sidelink positioning signal;
obtaining configuration signaling dedicated to the node device; and
obtaining signaling indicated by other node devices.

6. The method of claim 1, wherein determining the resources for transmitting the sidelink positioning signal based on the information indicated by the received first SCI comprises at least one of:
if the received first SCI indicates the resources for the sidelink positioning signal, determining that the resources indicated by the received first SCI are used for transmitting the sidelink positioning signal, or determining that other resources separate from the resources indicated by the first SCI are used for transmitting the sidelink positioning signal;
if the sidelink positioning signal is multiplexed on a PSSCH and the received first SCI indicates PSSCH resources, determining that the PSSCH resources indicated by the received first SCI are used for transmitting the sidelink positioning signal, or determining that other resources separate from the PSSCH resources indicated by the received first SCI are used for transmitting the sidelink positioning signal; and
if the sidelink positioning signal is multiplexed on the PSSCH and the received first SCI indicates the resources for the sidelink positioning signal and the PSSCH resources, determining that the resources indicated by the received first SCI are used for transmitting the sidelink positioning signal, or determining that other resources separate from the resources indicated by the received first SCI are used for transmitting the sidelink positioning signal.

7. The method of claim 1, wherein determining the resources for transmitting the sidelink positioning signal based on the received inter-node coordination information includes at least one of the following:
if the inter-node coordination information indicates the resources for the sidelink positioning signal, determining that the resources indicated by the inter-node coordination information are used for transmitting the sidelink positioning signal;
if the sidelink positioning signal is multiplexed on a PSSCH and the inter-node coordination information indicates PSSCH resources, determining that the PSSCH resources indicated by the inter-node coordination information are used for transmitting the sidelink positioning signal; and
if the sidelink positioning signal is multiplexed on the PSSCH and the inter-node coordination information indicates the resources for the sidelink positioning signal and the PSSCH resources, determining that the resources indicated by the inter-node coordination information are used for transmitting the sidelink positioning signal.

8. The method of claim 1, wherein determining the resources for transmitting the sidelink positioning signal based on the information indicated in the request signaling comprises at least one of:
if the request signaling indicates the resources for the sidelink positioning signal, determining that the resources indicated by the request signaling are used for transmitting the sidelink positioning signal;
if the sidelink positioning signal is multiplexed on a PSSCH and the request signaling indicates PSSCH resources, determining that the PSSCH resources indicated by the request signaling are used for transmitting the sidelink positioning signal; and
if the sidelink positioning signal is multiplexed on the PSSCH and the request signaling indicates the resources for the sidelink positioning signal and the PSSCH resources, determining that the resources indicated by the request signaling are used for transmitting the sidelink positioning signal.

9. The method of claim 1, wherein determining the resources for transmitting the sidelink positioning signal based on channel sensing comprises:
determining a candidate resource set;
obtaining a monitoring result of a channel within a resource sensing window;
excluding candidate resources satisfying specific conditions from the candidate resource set based on the monitoring result; and
determining the resources for transmitting the sidelink positioning signal from remaining candidate resources in the candidate resource set.

10. The method of claim 1, further comprising at least one of:
determining resources used by a second SCI associated with the sidelink positioning signal, and transmitting the second SCI on the resources used by the second SCI; and
transmitting the sidelink positioning signal and the second SCI associated with the sidelink positioning signal on the determined resources for transmitting the sidelink positioning signal.

11. The method of claim 10, wherein the second SCI associated with the sidelink positioning signal comprises information indicating at least one of resources for the sidelink positioning signal and PSSCH resources, wherein:
the second SCI indicates a resource location used by the sidelink positioning signal;
the second SCI indicates subsequent other resource locations to be used by the sidelink positioning signal;
the second SCI indicates information of a resource set used by the sidelink positioning signal;
the second SCI indicates information of subsequent other resource sets to be used by the sidelink positioning signal;
the second SCI indicates information of resources used by the sidelink positioning signal;
the second SCI indicates information of subsequent other resources to be used by the sidelink positioning signal;
the second SCI indicates the resource location of the sidelink positioning signal in a same resource pool as the second SCI;
the second SCI indicates a resource location of a PSSCH in a same resource pool as the second SCI;
the second SCI indicates the resource location of the sidelink positioning signal in a different resource pool from the second SCI; and
the second SCI indicates physical quantity based parameters of the sidelink positioning signal.

12. A method performed by a node device in a communication system, the method comprising:
determining resources for receiving a sidelink positioning signal;
receiving the sidelink positioning signal on the determined resource; and
measuring the sidelink positioning signal;
wherein, determining the resources for receiving the sidelink positioning signal comprises at least one of:
determining the resources for receiving the sidelink positioning signals based on at least one of a mapping rule and specific parameters;
determining the resources for receiving the sidelink positioning signal based on information indicated by received first sidelink control information (SCI);
determining the resources for receiving the sidelink positioning signal based on received inter-node coordination information;
determining the resources for receiving the sidelink positioning signal based on information indicated in request signaling if triggered by the request signaling to receive the sidelink positioning signal; and
determining the resources for receiving the sidelink positioning signal based on channel sensing.

13. The method of claim 12, further comprising obtaining, from a higher layer or other nodes, at least one of:
first information of a resource pool for receiving the sidelink positioning signal;
second information of a resource set for receiving the sidelink positioning signal; and
third information of resources for receiving the sidelink positioning signal.

14. The method of claim 12, wherein determining the sidelink positioning signal is multiplexed on a physical sidelink shared channel (PSSCH) based on at least one of the information indicated by the received first SCI, the inter-node coordination information, the request signaling, a configuration of a higher layer or a base station, and a predefined rule.

15. The method of claim 12, wherein determining the resources for receiving the sidelink positioning signal based on at least one of the mapping rule and specific parameters comprises at least one of:
obtaining a plurality of resource sets, and determining at least one resource set among the plurality of resource sets for receiving the sidelink positioning signal based on the at least one of the mapping rule and specific parameters; and
obtaining a plurality of resources in one or more resource sets, and determining at least one resource among the plurality of resources for receiving the sidelink positioning signal based on the mapping rule.

16. The method of claim 12, wherein determining the resources for receiving the sidelink positioning signal based on the information indicated by the received first SCI comprises at least one of:
if the received first SCI indicates the resources for the sidelink positioning signal, determining that the resources indicated by the received first SCI are used for receiving the sidelink positioning signal, or determining that other resources separate from the resources indicated by the first SCI are used for receiving the sidelink positioning signal;
if the sidelink positioning signal is multiplexed on a PSSCH and the received first SCI indicates PSSCH resources, determining that the PSSCH resources indicated by the received first SCI are used for receiving the sidelink positioning signal, or determining that other resources separate from the PSSCH resources indicated by the received first SCI are used for receiving the sidelink positioning signal; and
if the sidelink positioning signal is multiplexed on the PSSCH and the received first SCI indicates the resources for the sidelink positioning signal and the PSSCH, determining that the resources indicated by the received first SCI are used for receiving the sidelink positioning signal, or determining that other resources separate from the resources indicated by the received first SCI are used for receiving the sidelink positioning signal.

17. The method of claim 12, wherein determining the resources for receiving the sidelink positioning signal based on the received inter-node coordination information comprises at least one of:
if the inter-node coordination information indicates the resources for the sidelink positioning signal, determining that the resources indicated by the inter-node coordination information are used for receiving the sidelink positioning signal;
if the sidelink positioning signal is multiplexed on a PSSCH and the inter-node coordination information indicates the PSSCH resources, determining that the PSSCH resources indicated by the inter-node coordination information are used for receiving the sidelink positioning signal; and
if the sidelink positioning signal is multiplexed on the PSSCH and the inter-node coordination information indicates the resources for the sidelink positioning signal and the PSSCH resources, determining that the resources indicated by the inter-node coordination information are used for receiving the sidelink positioning signal.

18. The method of claim 12, wherein determining the resources for receiving the sidelink positioning signal based on the information indicated in the request signaling comprises at least one of:
if the request signaling indicates the resources for the sidelink positioning signal, determining that the resources indicated by the request signaling are used for receiving the sidelink positioning signal;
if the sidelink positioning signal is multiplexed on a PSSCH and the request signaling indicates PSSCH resources, determining that the PSSCH resources indicated by the request signaling are used for receiving the sidelink positioning signal; and
if the sidelink positioning signal is multiplexed on the PSSCH and the request signaling indicates the resources for the sidelink positioning signal and the PSSCH resources, determining that the resources indicated by the request signaling are used for receiving the sidelink positioning signal.

19. The method of claim 12, further comprising at least one of:
determining resources used by the first SCI associated with the sidelink positioning signal, and receiving the first SCI on the resources used by the first SCI; and
receiving the sidelink positioning signal and a third SCI associated with the sidelink positioning signal on the determined resources for receiving the sidelink positioning signal.

20. A node device, comprising:
a transceiver; and
a processor coupled to the transceiver and configured to:
determine resources for transmitting a sidelink positioning signal; and
transmit the sidelink positioning signal on the determined resources;
wherein determining the resources for transmitting the sidelink positioning signal comprises at least one of:
determine the resources for transmitting the sidelink positioning signal based on at least one of a mapping rule and specific parameters;
determine the resources for transmitting the sidelink positioning signal based on information indicated by received first sidelink control information (SCI);
determine the resources for transmitting the sidelink positioning signal based on received inter-node coordination information;
determine the resources for transmitting the sidelink positioning signal based on information indicated in request signaling if triggered by the request signaling to transmit the sidelink positioning signal; and
determine the resources for transmitting the sidelink positioning signal based on channel sensing.
